(19) United States
(12) Patent Application Publication
(10) Pub. No.: US 2021/0004431 A1
(43) Pub. Date: Jan. 7, 2021

(54) AUTOMATIC DETECTION AND EXTRACTION OF WEB PAGE DATA BASED ON VISUAL LAYOUT

(71) Applicant: Microsoft Technology Licensing, LLC, Redmond, WA (US)

(72) Inventors: Ziliu LI, Bellevue, WA (US); Edward Woodrow WILD, Bothell, WA (US); Junaid AHMED, Bellevue, WA (US)

(73) Assignee: Microsoft Technology Licensing, LLC, Redmond, WA (US)

(21) Appl. No.: 16/459,783

(22) Filed: Jul. 2, 2019

(51) Int. Cl. G06F 17/22; G06F 17/24; G06K 9/00; G06F 17/21; G06F 17/27; G06K 9/68; G06F 16/958

(52) U.S. Cl. CPC G06F 17/2247; G06F 17/241; G06F 17/248; G06K 9/00449; G06F 16/972; G06F 17/2765; G06K 9/6828; G06K 9/00463; G06F 17/212

(57) ABSTRACT

A system and method for automatically detecting and extracting entity data from a web page is provided. The method may include detecting a pattern for an entity based on a visual layout of the web page. A region of the webpage corresponding to the pattern may be identified as including the entity data, where the entity data is in a semi-structured form. Within the region, properties associated with the entity may be detected, annotations for the properties may be determined, and a category for the entity may be identified, where the properties, annotations, and category may be used to construct a schema for a structured form of the entity data. A template may be generated based on the schema and applied to the web page to extract the entity data in the structured form.

### BACKGROUND

Web pages often contain a large amount of data that may be desirable to be extracted. However, existing methods and techniques for web page data detection and extraction rely on the application of human-annotated and labeled templates or rules that are dependent on XML Path language (Xpath) or markup information from a document object model (DOM) tree for the web page. Resultantly, these templates and rules are often specific to the particular web page for which they are created and fail when the Xpath or the markup information changes, which can occur frequently, leading to high costs to recreate the templates or rules and inefficiencies in the data extraction.

It is with respect to these and other general considerations that the aspects disclosed herein have been made. Also, although relatively specific problems may be discussed, it should be understood that the examples should not be limited to solving the specific problems identified in the background or elsewhere in this disclosure.

### SUMMARY

Examples of the present disclosure are generally directed to detection and extraction of entity data from a web page based on a visual layout of the web page. Web pages may comprise semi-structured data associated with various entities. Repeated patterns for the entities may occur in the visual layouts of web pages across different domains. These repeated patterns may be leveraged to detect the data related to the respective entities within a web page. A template may be generated based on a schema for a structured form of the data, and applied to the web page to extract the data in the structured form from the webpage. In some examples, the template may be applied to other web pages to extract structured data from the other web pages. In further examples, the extracted structured data may be provided for use in other services, such as services utilizing a knowledge graph, a relational database, or a search engine, among other examples.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the description which follows and, in part, will be apparent from the description, or may be learned by practice of the disclosure.

### BRIEF DESCRIPTION OF THE DRAWINGS

Non-limiting and non-exhaustive examples are described with reference to the following figures.

FIG. 1 illustrates details of a system for automatically detecting and extracting entity data from a web page in accordance with the aspects of the disclosure;

FIG. 2 depicts a process flow diagram for automatically detecting and extracting structured entity data from a web page in accordance with examples of the present disclosure;

FIG. 3 depicts an example web page from which media content item data may be automatically detected and extracted in accordance with examples of the present disclosure;

FIG. 4 depicts an example web page from which rental property data may be automatically detected and extracted in accordance with examples of the present disclosure;

FIG. 5 depicts an example web page from which hotel data may be automatically detected and extracted in accordance with examples of the present disclosure;

FIG. 6 depicts an example web page from which lodging data may be automatically detected and extracted in accordance with examples of the present disclosure;

FIG. 7 depicts an example web page from which event data may be automatically detected and extracted in accordance with examples of the present disclosure;

FIG. 8 depicts an example web page from which product data may be automatically detected and extracted in accordance with examples of the present disclosure;

FIG. 9 depicts a method for automatically detecting and extracting entity data from a web page based on a visual layout in accordance with examples of the present disclosure;

FIG. 10 depicts a method for automatically detecting entity data from a web page in accordance with examples of the present disclosure;

FIG. 11 depicts a method for automatically extracting entity data from a web page in accordance with examples of the present disclosure;

FIG. 12 depicts a block diagram illustrating example physical components of a computing device with which aspects of the disclosure may be practiced;

FIG. 13A depicts a simplified block diagram of a computing device with which aspects of the present disclosure may be practiced;

FIG. 13B depicts another simplified block diagram of a mobile computing device with which aspects of the present disclosure may be practiced; and

FIG. 14 depicts a simplified block diagram of a distributed computing system in which aspects of the present disclosure may be practiced.

### DETAILED DESCRIPTION

Various aspects of the disclosure are described more fully below with reference to the accompanying drawings, which form a part hereof, and which show specific example aspects. However, different aspects of the disclosure may be implemented in many different forms and should not be construed as limited to the aspects set forth herein; rather, these aspects are provided so that this disclosure will be thorough and complete, and will fully convey the scope of the aspects to those skilled in the art. Aspects may be practiced as methods, systems or devices. Accordingly, aspects may take the form of a hardware implementation, an entirely software implementation or an implementation combining software and hardware aspects. The following detailed description is, therefore, not to be taken in a limiting sense.

Web pages comprise a wealth of data, and extraction of such data may be desirable for use in other services. However, the data may typically be in a semi-structured form within the web page, and thus extraction often involves structuring of the data. Existing methods and techniques for web page data detection and extraction rely on human-created templates or rules that are dependent on XML Path language (Xpath) or markup information from a document object model (DOM) tree. For example, extensible markup language (XML) may define a set of rules for encoding a web page as an XML document that is both human-readable and machine-readable. The DOM tree represents the XML document as a tree structure, where each node in the DOM tree is an object representing a part of the web page and one or more of the objects include the markup information. Xpath may be based on the tree representation of the XML document, and provides the ability to navigate around the tree (e.g., enables node selection by a variety of criteria), and may be used to compute values from content of the XML document.

Given the dependency on the Xpath and markup information in creating the templates and rules, the templates and rules may often be specific to a particular web page or website. Therefore, if data is to be extracted from another page or website that is slightly different, a different template or rule may need to be created. Additionally, once the Xpath or the markup information from the DOM tree used to create a template or rule changes, the template or rule may be broken and the data extraction will fail. Resultantly, a new template or rule may need to be created. Further, each of these templates and rules being created are generated by human label and annotation, leading to high cost and limitations in scalability.

To overcome the deficiencies of these existing methods and techniques, examples are described herein to automatically detect and extract entity data from a web page based on a visual layout of the web page. For example, an entity may be identified based on pattern regions detected within the visual layout, and entity data may be detected based at least upon distinct structures of the visual layout detected within the pattern region. A template may be generated based on a schema developed for a structured form of the detected entity data, and applied to the web page to extract the entity data in the structured form. The template can be applied not only to the web page, but also across other web pages in a same website and across web pages in different domains having the same or similar entities.

By leveraging the visual layout rather than the Xpath or markup information, changes to the Xpath or markup information will not impact the data extraction. Additionally, the visual layout of a web page rarely changes or at least changes with significantly less frequency than the Xpath or markup information, and even if the visual layout does change, pattern regions within a modified visual layout may be easily detectable and a new template may be automatically generated. Accordingly, by leveraging the visual layout to automatically detect and extract the entity data, the cost and scalability limitations of the existing methods for web page data detection and extraction may be removed.

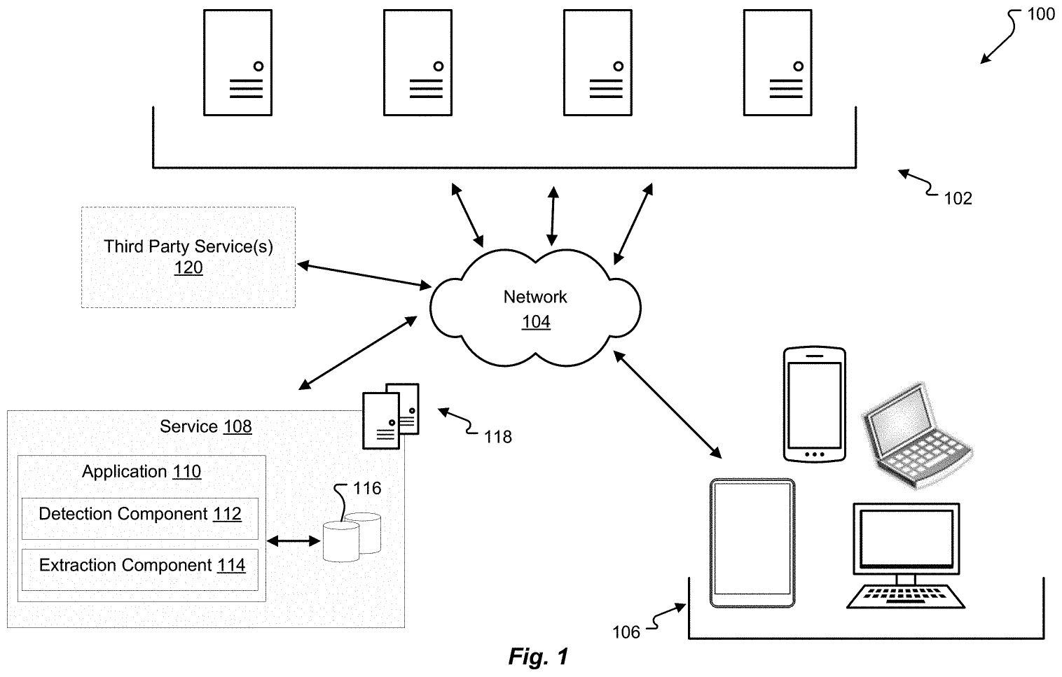

FIG. 1 depicts a system 100 for automatically detecting and extracting entity data from a web page in accordance with the aspects of the disclosure. The system 100 may generally include a plurality of web servers 102. Each of the web servers 102 may be configured to store, process, and deliver web pages via the network 104 to one or more endpoints, also referred to as user devices and/or a client devices 106. User agents, such as web browsers or web crawlers, associated with each of the client devices 106 may initiate communication between the client devices 106 and the plurality of web servers 102. For example, a user agent associated with one of the client devices 106 may make a request for a specific web page. The specific web page may be stored by one or more of the web servers 102, and at least one of the web servers 102 storing the web page may respond to the request by delivering the web page to the client device 106. As a non-limiting example, the client devices 106 may be any device configured to allow a user to use an application such as, for example, a smartphone, a tablet computer, a desktop computer, laptop computer device, gaming devices, media devices, smart televisions, multimedia cable/television boxes, smart phone accessory devices, industrial machinery, home appliances, thermostats, tablet accessory devices, personal digital assistants (PDAs), or other Internet of Things (TOT) devices.

The system 100 may also include a service 108 for detecting and extracting entity data from the web pages delivered from the web servers 102 to the client devices 106. The service 108 may include one or more processing servers 118, of which, at least one may be operable to execute one or more components of the service 108, including application 110, discussed herein. Additionally, the service 108 may include one or more databases 116 to store data. For example, the one or more databases 116 may be configured to store web pages, schemas, templates and extracted structured entity data, among other data, discussed in further detail below.

In some aspects, the service 108 may operate independently from the web servers 102 and the client devices 106. For example, the service 108 may intercept the web pages as they are being delivered from the web servers 102 to the client devices 106 over the network 104 and execute the application 110 to detect and extract the entity data. In other examples, the service 108 may interoperate with the client devices 106. For example, the client devices 106 may execute a thin version of the application 110 (e.g., a web browser) or a thick version of the application 110 that is installed on the client device. (e.g., a locally installed application). The application 110 may be executed upon receipt of web pages delivered from the web servers 102 at the client devices 106. In further aspects, the service 108 may be interoperate with the web servers 102. For example, the web servers 102 may execute the application 110 to detect and extract entity data from a web page in response to receiving a request for the web page from the client devices 106 at the web servers 102.

The application 110 of the service 108 may include a detection component 112 and an extraction component 114. The detection component 112 may be configured to detect entity data within web pages delivered from the web servers 102 to the client devices 106. The entity data may be detected based on a visual layout of the web pages, where the entity data may be in a semi-structured form within the webpages. The extraction component 114 may be configured to extract the entity data in a structured form from the web pages. For example, a template may be generated based on a schema developed for the structured form of the entity data, and the template may be applied to a web page to extract the entity data in the structured form (e.g., to extract structured entity data).

In some aspects, the template generated may be applied to one or more other web pages to extract the structured entity data from the other web pages. In some examples, the other web pages may be associated with a same website as the web page (e.g., may have a similar URL pattern). In other examples, the other web pages may be across different domains having same or similar entities.

In further aspects, the extracted, structured entity data may be provided for use in one or more services. In some examples, the service 108 may itself use the extracted, structured entity data to fill in other services provided. In other examples, the service 108 may provide the extracted, structured entity data to one or more third party services 120. For example, the extracted, structured entity data may be used to enhance knowledge graphs, relational databases, or search engines associated with the service 108 and/or the third party services 120.

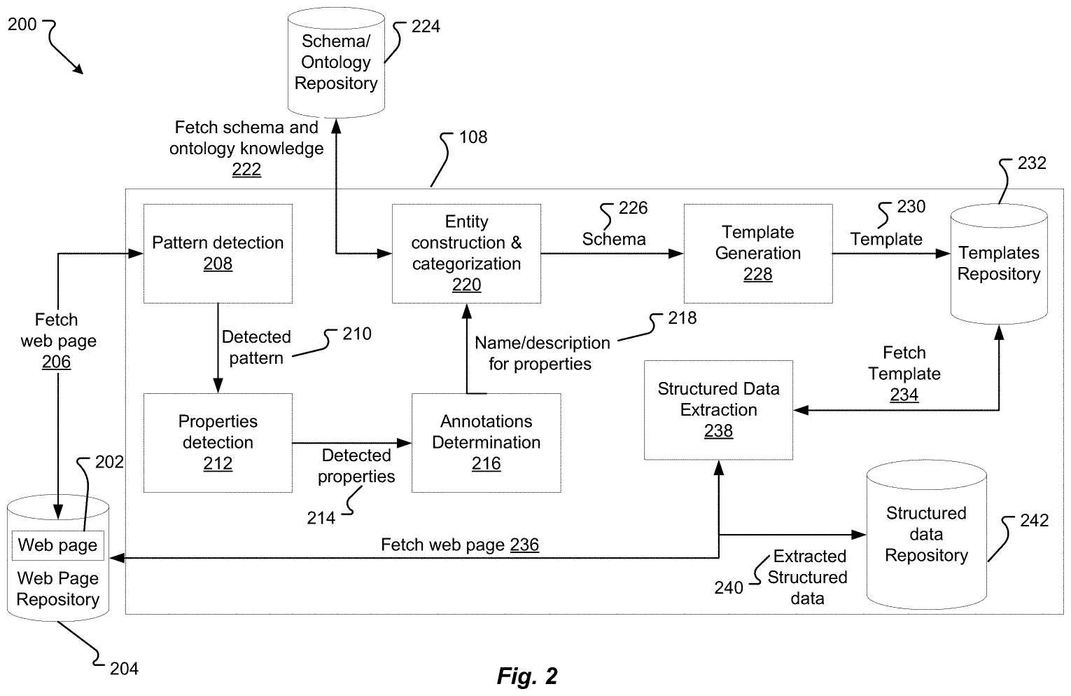

FIG. 2 depicts a process flow diagram 200 for automatically detecting and extracting structured entity data from a web page in accordance with examples of the present disclosure. In some aspects, the system 100 described in FIG. 1 may be an example system configured to implement the process flow illustrated.

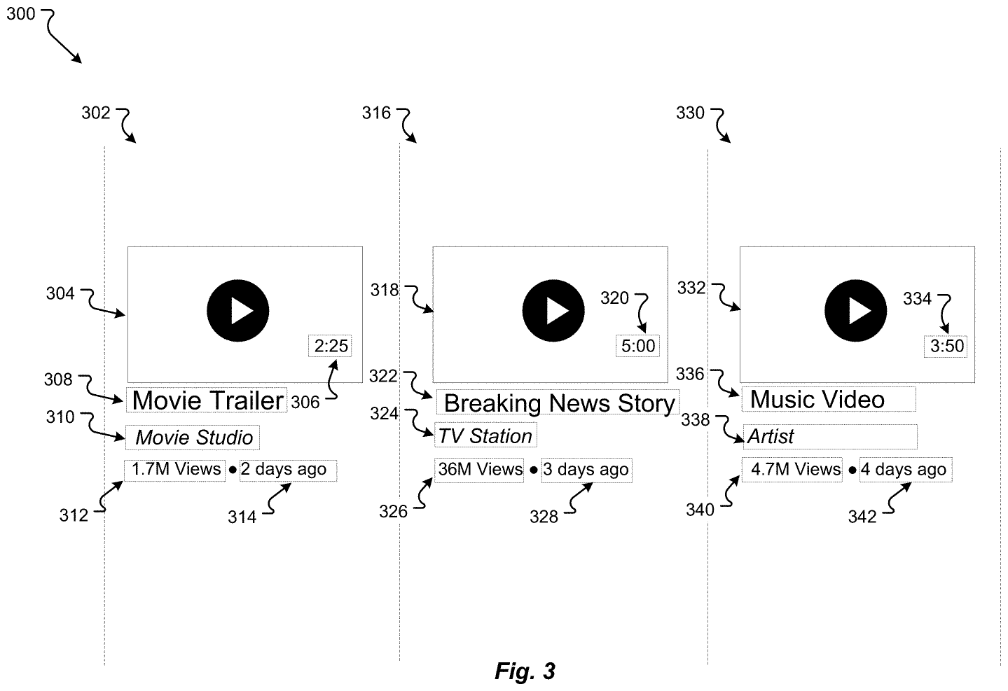

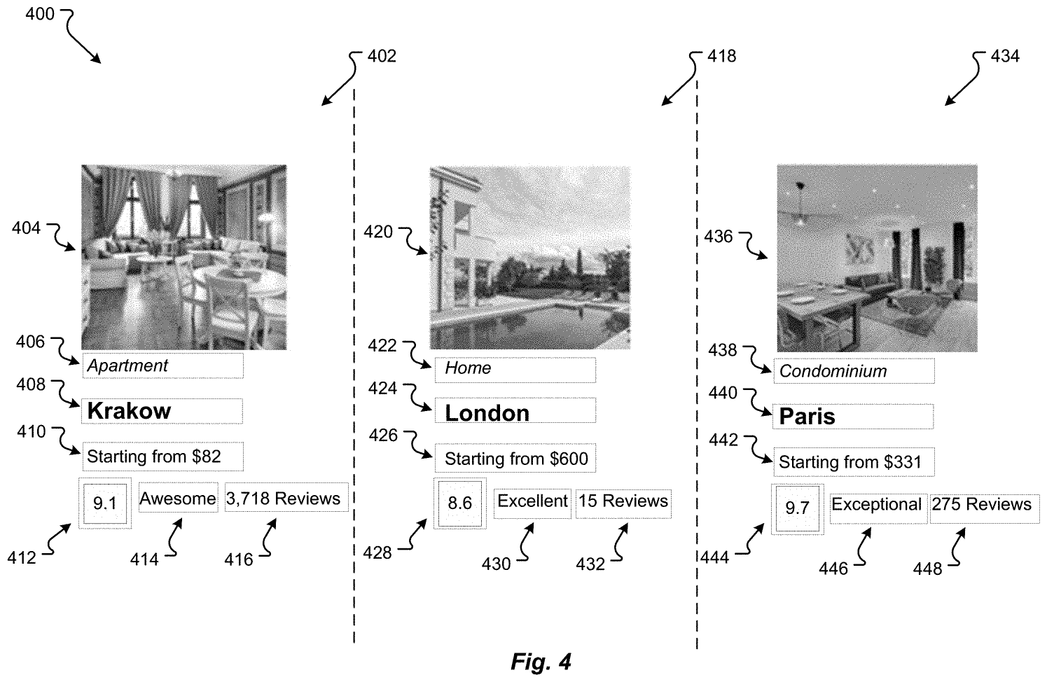

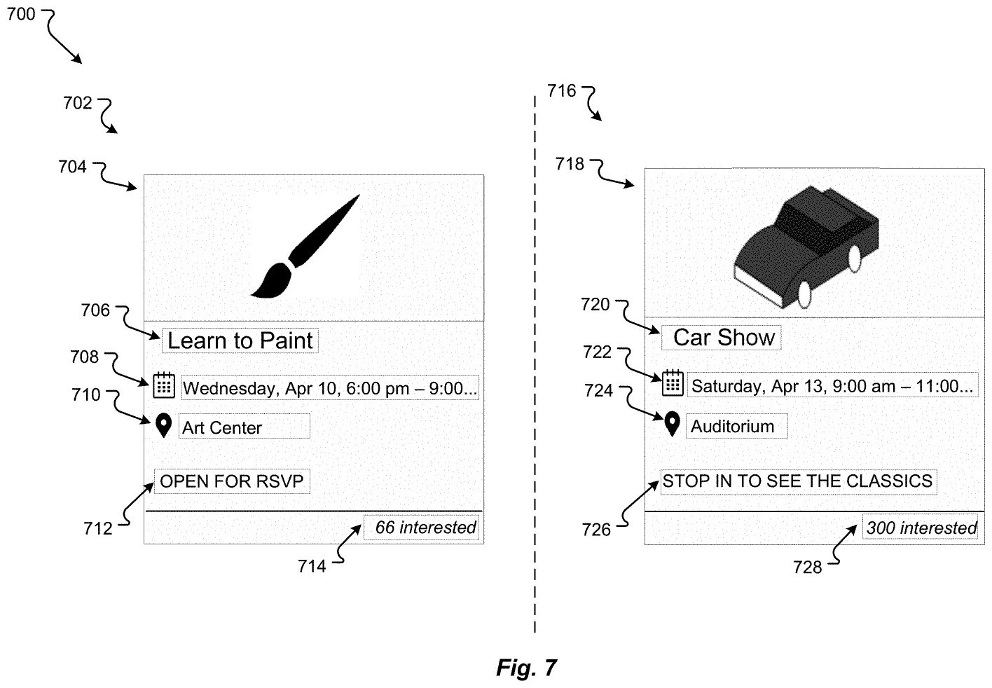

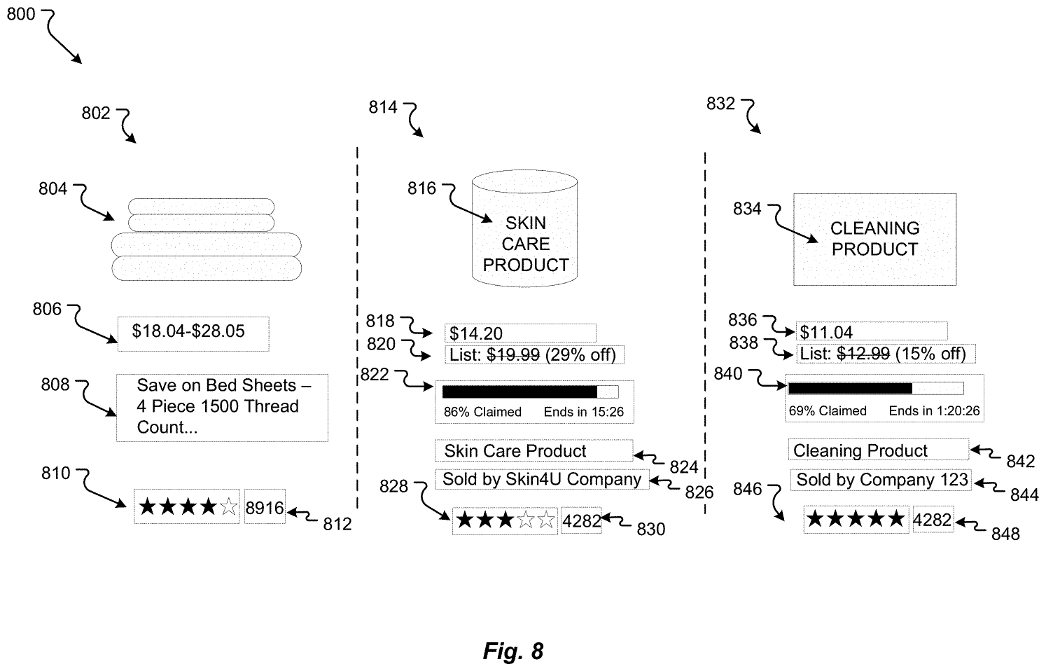

The service 108 may fetch a web page 202 from a web page repository 204 (e.g., from a database of one of the web servers 102) at operation 206. The web page 202 may include data associated with an entity, where the entity data may be semi-structured within the web page 202. To provide a few, non-limiting examples, the entity may include a media content item as illustrated in FIG. 3, a hotel or other similar lodging as illustrated in FIGS. 4, 5, and 6, an event as illustrated in FIG. 7, and a product as illustrated in FIG. 8.

At operation 208, the service 108 may detect a pattern 210 for the entity within a visual layout of the web page 202 at operation 208. The detected pattern 210 may correspond to a region of the web page 202 comprising the entity data. In example aspects, to detect the pattern 110, a plurality of candidates for the pattern may be generated using one or more algorithms. For example, a brute force algorithm, a heuristic algorithm and/or a machine learning based algorithm, among other similar algorithms, may be used to detect the plurality of candidates based on the visual layout of the web page 202. A classifying mechanism may then be implemented to determine one candidate among the plurality of candidates for selection as the detected pattern 210 for the entity.

Within the region corresponding to the detected pattern 210, one or more properties of the entity are detected at operation 212. The properties may be detected based on distinct structures of the visual layout detected within the region. For example, a distinct structure of the visual layout may be detected within the region, and a candidate property corresponding to the distinct structure may be identified. In some aspects, the candidate property may be validated by comparing the candidate property to another candidate property created for another region of the web page 202 corresponding to a same detected pattern 210. Distinct structures of the visual layout may include distinct fonts. As one example, a font may be distinct if the font comprises one or more of a distinct font family, font size, font style, font variant, and font weight from other fonts within the region. Other example distinct structures may be based on an arrangement, position, or orientation of text or graphical content within the region.

At operation 216, annotations for the detected properties 214 may be determined. The annotations may include names and/or descriptions 218 for the detected properties 214. The web page 202 may be encoded as an XML document and represented as a tree structure by a DOM tree, where each node in the DOM tree is an object representing a part of the web page and one or more of the objects include markup information. In some examples, the annotations may be determined using markup information from the DOM tree. In other examples, annotations may be determined from textual content or other content features of the web page 202. For example, named-entity recognition may be applied to detect whether textual content associated with a detected property includes an address, a name, or a number, among other similar information. Additionally, the annotations may be inferred by other content from the web page 202 or the website the web page 202 is associated with. In further examples, ontology information retrieved at operation 222 and a category determined for the entity at operation 220 may be leveraged to determine or adjust the names and/or descriptions 218 for the detected properties 214.

At operation 220, a category for the entity may be determined and a schema may be constructed. Schema and ontology knowledge may be retrieved at operation 222 from a repository 224. As illustrated, the repository 224 may be external to the service 108. In other examples, the repository 224 may be a database (e.g., one of the databases 116) of the service 108. In some aspects, the category is determined based on the names and/or descriptions 218 for the detected properties 214. Additionally or alternatively, the category may be inferred based on one or more topics and keywords identified from the content of the webpage. Determining and/or inferring the category may enable different types of entities that have similar properties to be distinguished from one another. A schema 226 for a structured form of the entity data may then be constructed based on the detected properties 214, names and/or descriptions 218 for the detected properties 214, and the category.

At operation 228, a template 230 is generated based on the schema 226 and stored in a templates repository 232 of the service 108. In some examples, the template 230 may be a template based on a visual layout. For example, information corresponding to the visual layout of the web page 202 is embedded into the template 230, and the information is used to identify a location of the entity data within the document. In other aspects, the template 230 may be a rule based or tree node template. For example, the template 230 contains rules, in form of a regular expression (“regex”) or Xpath, among other similar examples, that define how to locate content in the web page 202 based on a text or metadata of the web page. For example, how to locate the content based on markup information (e.g., a markup name or markup attribute) from the DOM tree.

At operations 234 and 236, the template 230 and the web page 202 may be respectively fetched from the templates repository 232 and the web page repository 204, and the template 230 may be applied to the web page 202 to extract the entity data in the structured form (i.e., structured entity data 240) at operation 238. The extracted structured entity data 240 may then be stored in a structured data repository of the service 108.

In some aspects, one or more other web pages may be fetched from the web page repository 204 (or other web page repository of another web server), and the template 230 may be applied to the other web pages to extract the structured entity data from the other web pages. The extracted structured entity data from the other web pages may similarly be stored in the structured data repository 242.

In further aspects, the extracted structured entity data stored in the structured data repository 242, including the extracted structured entity data 240, may be provided for use in one or more services. For example, services utilizing knowledge graphs or relational databases and/or providing search engines, among others.

The template 230 may be stored and used to extract structured entity data from a plurality of webpages until the template 230 fails. Upon detecting failure of the template 230, the process flow illustrated in process flow diagram 200 may be repeated.

FIG. 3 depicts an example web page 300 from which media content item data may be automatically detected and extracted in accordance with examples of the present disclosure. The web page 300 may be a web page associated with a video sharing site through which users may search for, select, and play various media content items. A repetitive pattern for entities may be detected based on a visual layout of the web page 300, where the entities may be the various media content items, for example. The pattern may correspond to regions 302, 316, and 330 of the web page 300, where each region comprises data related to a respective media content item. For example, a first region 302 may comprise data related to a first media content item (e.g., a video clip of a movie trailer), the second region 316 may comprise data related to a second media content item (e.g., a video clip of a news story), and the third region 330 may comprise data related to a third media content item (e.g., a video clip of a music video). The media content item data may be semi-structured within the web page 300. Based on aspects described herein, the media content item data from the web page 300 may be detected and extracted as structured data corresponding to a more formal data structure.

To detect the media content item data, one or more properties associated with a respective media content item are detected within each region. To identify the properties, one or more distinct structures of the visual layout are detected within each region. A candidate for a property may be identified for and correspond to each distinct structure detected. The candidate may be validated by comparing the candidate to another candidate of another region of the web page 300 corresponding to the pattern. For example, within the first region 302, candidate properties 304, 306, 308, 310, 312, and 314 for the first media content item may be identified. Within the second region 316, candidate properties 318, 320, 322, 324, 326, and 328 for the second media content item may be identified. Within the third region 330, candidate properties 332, 334, 336, 338, 340, and 342 may be identified for the third media content item 332. To validate the candidate properties, candidate property 306 in the first region 302 may be compared to candidate property 320 in the second region 316 and/or candidate property 334 in the third region 330. Similarly, candidate property 308 in the first region 302 may be compared to candidate property 322 in the second region 316 and/or candidate property 336 in the third region 330, and so on.

Once the properties for the respective media content item are detected, annotations may be determined for the properties. The annotations may include a name or a description of the properties. For example, within the first region 302, the annotations for the properties may include a media object for property 304, a length of the media object for property 306, a media content item title for property 308, and a media content item producer for property 310. The annotations may also include a view count on the video sharing web site for property 312, and a publication date on the video sharing site for property 314. The annotations for the properties detected within the second region 316 and the third region 330 may be the same or similar. In some aspects, the annotations may be determined using markup information from a DOM tree representing the web page 300, textual content of the web page 300, and/or other content features of the web page 300. As one example, an object in the DOM tree corresponding to property 308 of the first region may include the annotation “title” within the markup information. As another example, named-entity recognition may be applied to the textual content associated with the property 310 to determine that the textual content “Movie Studio” represents a producer's name. In other aspects, the annotations may be determined or adjusted based on the category identified for the respective media content items, described below.

A category for the entities may be identified. In some examples, the category may be identified based on one or more of the determined annotations. For example, based on at least the annotations for the media object, length of media object, and media content item producer, the category for the entities may be identified as media content items. Additionally or alternatively, the category may be inferred based on one or more topics and keywords identified from content of the web page 300. For example, the web page 300 may include textual content reciting “Top Rated Videos”.

A schema for a structured form of the media content item data may be constructed based on the detected properties, determined annotations, and identified category. A template may be generated based on the schema and applied to the web page 300 to extract the media content item data in the structured form (i.e., structured media content item data). The extracted, structured media content item may then be stored and/or provided for use in other services. In some aspects, the template may be applied to other web pages to extract structured media content item data. The other web pages may be within a same domain as the web page 300. For example, the template may be applied to another web page associated with a same website as web page 300 (e.g., the website associated with the video sharing service). Additionally or alternatively, the web pages may be in a different domain presenting similar content. For example, the template may be applied to another web page associated with a different domain.

FIG. 4 depicts an example web page 400 from which rental property data may be automatically detected and extracted in accordance with examples of the present disclosure. The web page 400 may be a web page associated with a travel web site through which users may search for and book various types of rental properties. A repetitive pattern for entities may be detected based on a visual layout of the web page 400, where the entities may be the various rental property options (e.g., homes, apartments, condominiums, flats, cottages, chalets, etc.). The pattern may correspond to regions 402, 418, and 434 of the web page 400, where each region comprises data related to a rental property option. For example, a first region 402 may comprise data related to a first rental property option (e.g., an apartment), the second region 418 may comprise data related to a second rental property option (e.g., a home), and the third region 434 may comprise data related to a third rental property option (e.g., a condominium). The data associated with the rental property options may be semi-structured within the web page 400. Based on aspects described herein, the rental property data from the web page 400 may be detected and extracted as structured rental property data.

To detect the rental property data, one or more properties associated with a respective rental property option are detected within each region. To identify the properties, one or more distinct structures of the visual layout are detected within each region. A candidate for a property may be identified for and correspond to each distinct structure detected. The candidate may be validated by comparing the candidate to another candidate of another region of the web page 400 corresponding to the pattern. For example, within the first region 402, candidate properties 404, 406, 408, 410, 412, 414 and 416 for the first rental property option are identified. Within the second region 418, candidate properties 420, 422, 424, 426, 428, 430 and 432 for the second rental property option are identified. Within the third region 434, candidate properties 436, 438, 440, 442, 444, 446, and 448 for the third rental property option are identified. To validate the candidate properties, candidate property 406 in the first region 402 may be compared to candidate property 420 in the second region 418 and/or candidate property 436 in the third region 434. Similarly, candidate property 406 in the first region 402 may be compared to candidate property 422 in the second region 418 and/or candidate property 438 in the third region 434, and so on.

Once the properties for the respective rental property options are detected, annotations may be determined for the properties. The annotations may include a name or a description of the properties. For example, within the first region 402, the annotations may include an image of the rental for the property 404, a rental type for property 406, a location of the rental for property 408, and a rental price for the property 410. The annotations may also include a review summary for the rental, including a numerical rating for property 412, a verbal rating corresponding to the numerical rating for property 414, and a review count for property 416. The annotations for the properties detected within the second region 418 and the third region 434 may be the same or similar. In some aspects, the annotations may be determined using the markup information from a DOM tree representing the web page 400, textual content of the web page 400, and/or other content features of the web page 400. As one example, the object in the DOM tree corresponding to property 406 of the first region may include the annotation “rental type” within the markup information. As another example, named-entity recognition may be applied to the textual content associated with the property 408 to determine that the textual content “Krakow” represents a location. In other aspects, the annotations may be determined or adjusted based on the category identified for the respective rental property options, described below.

A category for the entities may be identified. In some aspects, the category may be identified based on one or more of the determined annotations. For example, based on at least the annotations of rental type, rental location, rental price, the category for the entities may be identified as rental properties or more broadly lodging. Additionally or alternatively, the category may be inferred based on one or more topics and keywords identified from content of the web page 300. For example, the web page 400 may include textual content reciting “vacation properties for rent near you”.

A schema for a structured form of the rental property data may be constructed based on the detected properties, determined annotations, and identified category. A template may be generated based on the schema and applied to the web page 400 to extract the rental property data in the structured form (i.e., structured rental property data). The extracted structured rental property data may then be stored and/or provided for use in one or more services. In some aspects, the template may be applied to other web pages to extract structured rental property data from the other web page. The other web pages may be within a same domain as the web page 400. For example, the template may be applied to another web page associated with a same website as web page 400 (e.g., the travel web site). In another example, the template may be applied to another web page associated with a different domain that comprises rental property entities.

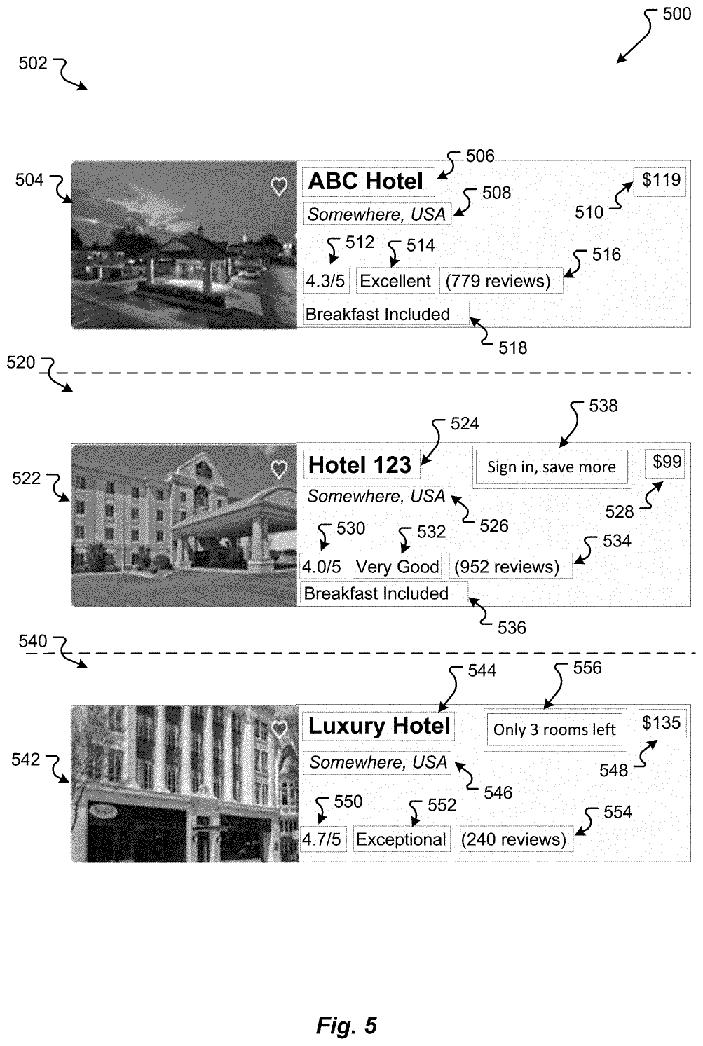

FIG. 5 depicts an example web page 500 from which hotel data may be automatically detected and extracted in accordance with examples of the present disclosure. The web page 500 may be a web page associated with a travel web site through which users may search for and book hotels, among other types of travel-related needs (e.g., flights, rental cars, etc.). A repetitive pattern for entities may be detected based on a visual layout of the web page 500, where the entities may be hotels returned in response to a user search, for example. The pattern may correspond to regions 502, 520, and 540 of the web page 500, where each region comprises data related to a hotel. For example, a first region 502 may comprise data related to a first hotel, the second region 520 may comprise data related to a second hotel, and the third region 540 may comprise data related to a third hotel. The data associated with the hotels may be semi-structured within the web page 500. Based on aspects described herein, the hotel data from the web page 500 may be detected and extracted as structured hotel data.

To detect the hotel data, one or more properties associated with a respective hotel are identified within each region. To identify the properties, one or more distinct structures of the visual layout are detected within each region. A candidate for a property may be identified for and correspond to each distinct structure detected. The candidate may be validated by comparing the candidate to another candidate of another region of the web page 500 corresponding to the pattern. For example, within the first region 502, candidate properties 504, 506, 508, 510, 512, 514, 516, and 518 for the first hotel are identified. Within the second region 520, candidate properties 522, 525, 526, 528, 530, 532, 534, and 538 for the second hotel are identified. Within the third region 540, candidate properties 542, 544, 546, 548, 550, 552, 554, and 556 for the third hotel are identified. To validate the candidate properties, candidate property 504 in the first region 502 may be compared to candidate property 522 in the second region 520 and/or candidate property 542 in the third region 540. Similarly, candidate property 506 in the first region 502 may be compared to candidate property 524 in the second region 520 and/or candidate property 544 in the third region 540, and so on.

Once the properties for the respective hotels are detected, annotations may be determined for the properties. The annotations may include a name or a description of the properties. For example, within the first region 502, the annotations may include an image for property 504, a hotel name for property 506, a hotel location for property 508, and a hotel price for the property 510. The annotations may also include a review summary, including a numerical rating for property 512, a verbal rating corresponding to the numerical rating for property 514, and a review count for property 516. The annotations may further include a hotel amenity for property 518. The annotations for the properties detected within the second region 520 and the third region 540 may be similar. Unique to the second region 520, the annotations may also include a sign in option for property 538 (e.g., corresponding to an actionable control element that a user may select to sign into a user account for the particular hotel to receive savings). Unique to the third region 540, the annotations may also include a room availability notification for property 556. In some aspects, the annotations may be determined using markup information from a DOM tree representing the web page 500, textual content of the web page 500, and/or other content features of the web page 500. As one example, an object in the DOM tree corresponding to property 506 of the first region may include the annotation “name” within the markup information. As another example, named-entity recognition may be applied to the textual content associated with the property 510 to determine that the textual content “$119” represents a monetary value or price. In other aspects, the annotations may be determined or adjusted based on the category identified for the respective lodging options, described below.

A category for the entities may be identified. In some aspects, the category may be identified based on one or more of the determined annotations. For example, based on at least the annotations hotel name, hotel location, and hotel price, the category for the entities may be identified as hotels or more broadly lodging. Additionally or alternatively, the category may be inferred based on one or more topics and keywords identified from content of the web page 300. For example, the web page 400 may include textual content reciting “hotel search results”.

A schema for a structured form of the hotel data may be constructed based on the detected properties, determined annotations, and identified category. A template may be generated based on the schema and applied to the web page 500 to extract the hotel data in the structured form (i.e., structured hotel data). The extracted structured hotel data may then be stored and/or provided for use in one or more services. In some aspects, the template may be applied to other web pages to extract structured hotel data from the other web pages. The other web pages may be within a same domain as the web page 500. For example, the template may be applied to another web page associated with a same website as web page 500 (e.g., the travel web site). Additionally or alternatively, the web pages may be in a different domain presenting similar content. For example, the template may be applied to another web page associated with a different domain that comprises hotel entities.

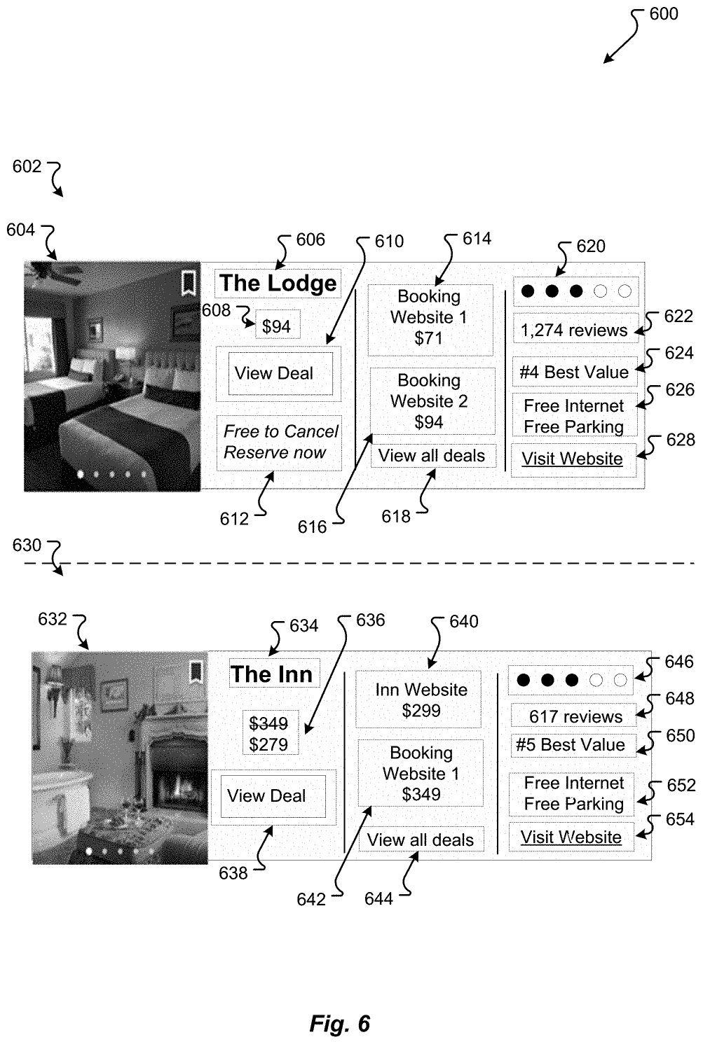

FIG. 6 depicts an example web page 600 from which lodging data may be automatically detected and extracted in accordance with examples of the present disclosure. The web page 600 may be a web page associated with a travel web site through which users may search for and book travel accommodations (e.g., flights, rental cars, lodging etc.). A repetitive pattern for entities may be detected based on a visual layout of the web page 600, where the entities may be lodging options returned in response to a user search, for example. The pattern may correspond to regions 602 and 630 of the web page 600, where each region comprises data related to a lodging option. For example, a first region 602 may comprise data related to a first lodging option and a second region 630 may comprise data related to a second lodging option. The data associated with the lodging options may be semi-structured within the web page 600. Based on aspects described herein, the lodging data from the web page 600 may be detected and extracted as structured lodging data.

To detect the lodging data, one or more properties associated with a respective lodging option are detected within each region. To identify the properties, one or more distinct structures of the visual layout are detected within each region. A candidate for a property may be identified for and correspond to each distinct structure detected. The candidate may be validated by comparing the candidate to another candidate of another region of the web page 600 corresponding to the pattern. For example, within the first region 602, candidate properties 604, 606, 608, 610, 612, 614, 616, 618, 620, 622, 624, 626, and 628 for the first lodging option are identified. Within the second region 630, candidate properties 632, 634, 636, 638, 640, 642, 644, 646, 648, 650, 652, and 654 for the second lodging option are identified. To validate the candidate properties, candidate property 604 in the first region 602 may be compared to candidate property 632 in the second region 630. Similarly, candidate property 606 in the first region 602 may be compared to candidate property 634 in the second region 630, and so on.

Once the properties for the respective lodging options are detected, annotations may be determined for the properties. The annotations may include a name or a description of the properties. For example, within the first region 602, the annotations may include an image for the property 604, a name of the lodging option for property 606, a lodging price for property 608, a view deal option for property 538 (e.g., corresponding to an actionable control element that a user may select to see more details about prices associated with the lodging option), and booking features associated with the lodging option for property 610 (e.g., free cancellation). The annotations may also include other websites (e.g., a website of the lodging option or other travel websites) and prices for the lodging option being offered by the other websites for properties 614, 616, and 618. The annotations may further include a review summary, including a graphical representation of a numerical rating for property 620, a review count for property 622, and a ranked value for property 624. The annotations may yet further include lodging amenities for property 626 and a lodging option website hyperlink for property 628. The annotations for the properties detected within the second region 630 may be the same or similar.

In some aspects, the annotations may be determined using markup information from a DOM tree representing the web page 600, textual content of the web page 600, and/or other content features of the web page 600. As one example, an object in the DOM tree corresponding to property 606 of the first region may include the annotation “name” within the markup information. As another example, named-entity recognition may be applied to the textual content associated with the property 608 to determine that the textual content “$94” represents a monetary value or price. In other aspects, the annotations may be determined or adjusted based on the category identified for the respective lodging options, described below.

A category for the entities may be identified. In some aspects, the category may be identified based on one or more of the determined annotations. For example, based on at least the annotations of name, booking features, and amenities, the category for the entities may be identified as lodging. Additionally or alternatively, the category may be inferred based on one or more topics and keywords identified from content of the web page 300. For example, the web page 400 may include textual content reciting “lodging options under $500”.

A schema for a structured form of the lodging data may be constructed based on the detected properties, determined annotations, and identified category. A template may be generated based on the schema and applied to the web page 600 to extract the lodging data in the structured form (i.e., the structured lodging data). The extracted structured lodging data may then be stored and/or provided for use in one or more services. In some aspects, the template may be applied to other web pages to extract structured lodging data from the other web page. The other web pages may be within a same domain as the web page 600. For example, the template may be applied to another web page associated with a same website as web page 600 (e.g., the travel web site). Additionally or alternatively, the web pages may be in a different domain presenting similar content. For example, the template may be applied to another web page associated with a different domain that comprises lodging entities.

FIG. 7 depicts an example web page 700 from which event data may be automatically detected and extracted in accordance with examples of the present disclosure. The web page 700 may be a web page associated with a directory service through which users may search for and obtain information about various events and businesses. A repetitive pattern for entities may be detected based on a visual layout of the web page 700, where the entities may be events, for example. The pattern may correspond to regions 702 and 716 of the web page 700, where each region comprises data related to a respective event. For example, a first region 702 may comprise data related to a first event (e.g., a painting class) and a second region 716 may comprise data related to a second event (e.g., a car show). The event data may be semi-structured within the web page 700. Based on aspects described herein, the event data from the web page 700 may be detected and extracted as structured event data.

To detect the event data, one or more properties associated with a respective event are detected within each region. To identify the properties, one or more distinct structures of the visual layout are detected within each region. A candidate for a property may be identified for and correspond to each distinct structure detected. The candidate may be validated by comparing the candidate to another candidate of another region of the web page 700 corresponding to the pattern. For example, within the first region 702, candidate properties 704, 706, 708, 710, 712, and 714 for the first event may be identified. Within the second region 716, candidate properties 718, 720, 722, 724, 726, and 728 for the second event may be identified. To validate the candidate properties, candidate property 704 in the first region 702 may be compared to candidate property 718 in the second region 716. Similarly, candidate property 706 in the first region 702 may be compared to candidate property 720 in the second region 716, and so on.

Once the properties for the respective event are detected, annotations may be determined for the properties. The annotations may include a name or a description of the properties. For example, within the first region 702, the annotations for the properties may include an image for property 704, an event title for property 706, a time for property 708, a location for property 710, event details for property 712, and an interest count for property 714. The second region 716 may include the same or similar annotations for the properties. In some aspects, the annotations may be determined using markup information from a DOM tree representing the web page 700, textual content of the web page 700, and/or other content features of the web page 700. As one example, an object in the DOM tree corresponding to property 706 of the first region 702 may include the annotation “event title” within the markup information. As another example, named-entity recognition may be applied to the textual content associated with the property 708 to determine that the textual content “Wednesday, April 10” represents a time expression. In other examples, the annotations may be determined or adjusted based on the category identified for the respective events, described below.

A category for the entities may be identified. In some aspects, the category may be identified based on one or more of the determined annotations. For example, based on the event title, time, location, and interest count annotations, the category may be identified as an event. Additionally or alternatively, the category may be inferred based on one or more topics and keywords identified from content of the webpage 700. For example, a heading on the web page may include the text “local upcoming events.”

A schema may be constructed based on the detected properties, determined annotations, and identified category. A template may be generated based on the schema and applied to the web page 700 to extract the structured event data. The extracted, structured event data may then be stored and/or provided to other services. In some aspects, the template may be applied to other web pages to extract structured event data. The other web pages may be within a same domain as the web page 700. For example, the template may be applied to another web page associated with a same website as web page 700 (e.g., a website associated with the business directory service). Additionally or alternatively, the web pages may be in a different domain presenting similar content. For example, the template may be applied to another web page associated with a different domain that comprises event entities.

FIG. 8 depicts an example web page 800 from which product data may be automatically detected and extracted in accordance with examples of the present disclosure. The web page 800 may be a web page associated with an electronic commerce service through which users may search for, view, and purchase products. A repetitive pattern for entities may be detected based on a visual layout of the web page 800, where the entities may be the products, for example. The pattern may correspond to regions 802, 814, and 832 of the web page 800, where each region comprises data related to a respective product. For example, a first region 802 may comprise data related to a first product (e.g., bed sheets), a second region 814 may comprise data related to a second product (e.g., a skin care product), and a third region 832 may comprise data related to a third product (e.g., a cleaning product). The product data may be semi-structured within the web page 800. Based on aspects described herein, the product data from the web page 800 may be detected and extracted as structured product data.

To detect the product data, one or more properties associated with a respective product are detected within each region. To identify the properties, one or more distinct structures of the visual layout are detected within each region. A candidate for a property may be identified for and correspond to each distinct structure detected. The candidate may be validated by comparing the candidate to another candidate of another region of the web page 800 corresponding to the pattern. For example, within the first region 802, candidate properties 804, 806, 808, 810 and 812 for the first product may be identified. Within the second region 814, candidate properties 816, 818, 820, 822, 824, 826, 828, and 830 for the second product may be identified. To validate the candidate properties, candidate property 804 in the first region 802 may be compared to candidate property 816 in the second region 814, and/or candidate property 834 in the third region 832. Similarly, candidate property 810 in the first region 802 may be compared to candidate property 828 in the second region 814, and/or candidate property 846 in the third region 832, and so on.

Once the properties for the respective event are detected, annotations may be determined for the properties. The annotations may include a name or a description of the properties. For example, within the first region 802, the annotations for the properties associated with the first product may include a product image for property 804, a product price for property 806, a product description for property 808, a product review summary for property 810, and a product review count for property 812. Within the second region 814, the annotations for the properties associated with the second product may include a product image for property 816, a product price for property 818, price discount information for property 820, and claiming period information for property 822 that includes a graphical representation and a percentage value of products claimed and a time remaining to claim for property. The annotations for the properties associated with the second product may further include a product name for property 824, a product seller for property 826, a product review summary for property 828, and a product review count for property 830. Within the third region 832, the annotations for the properties associated with the third product may include a product image for property 834, a product price for property 836, price discount information for property 838, and claiming period information for property 840 that includes a graphical representation and a percentage value of products claimed and a time remaining to claim for property. The annotations for the properties associated with the third product 834 may further include a product name for property 842, a product seller for property 844, a product review summary for property 846, and a product review count for property 848.

In some aspects, the annotations may be determined using markup information from a DOM tree representing the web page 800, textual content of the web page 800, and/or other content features of the web page 800. As one example, an object in the DOM tree corresponding to property 806 of the first region 802 may include the annotation “price” within the markup information. As another example, named-entity recognition may be applied to the textual content associated with the property 826 of the second region 814 to determine that the textual content “Skin4U Company” represents a company or organization. In other aspects, the annotations may be determined or adjusted based on the category identified for the respective events, described below.

A category for the entities may be identified. In some aspects, the category may be identified based on one or more of the determined annotations. For example, based on at least the annotations for price, seller, and claiming period, the category for the entities may be identified as products. Additionally or alternatively, the category may be inferred based on one or more topics and keywords identified from content of the web page 800. For example, the web page 800 may include textual content reciting “products for sale”.

A schema for a structured form of the product data may be constructed based on the detected properties, determined annotations, and identified category. A template may be generated based on the schema and applied to the web page 800 to extract the product data in the structured form (i.e., structured product data). The extracted structured product data may then be stored and/or provided to other services. In some aspects, the template may be applied to other web pages to extract structured product data. The other web pages may be within a same domain as the web page 800. For example, the template may be applied to another web page associated with a same website as web page 800 (e.g., a website associated with electronic commerce service). Additionally or alternatively, the web pages may be in a different domain presenting similar content. For example, the template may be applied to another web page associated with a different domain that comprises product entities.

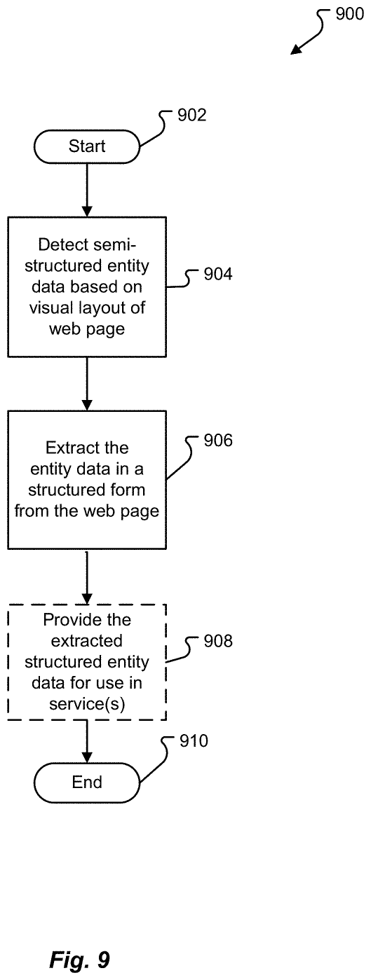

FIG. 9 depicts details of a method 900 for automatically detecting and extracting entity data from a web page in accordance with examples of the present disclosure. A general order for the steps of the method 900 is shown in FIG. 9. Generally, the method 900 starts with a start operation 902 and ends with the end operation 910. The method 900 may include more or fewer steps or may arrange the order of the steps differently than those shown in FIG. 9. The method 900 may be executed as a set of computer-executable instructions executed by a computer system and encoded or stored on a computer readable medium. Further, the method 900 may be performed by gates or circuits associated with a processor, Application Specific Integrated Circuit (ASIC), a field programmable gate array (FPGA), a system on chip (SOC), or other hardware device. Hereinafter, the method 900 shall be explained with reference to the systems, services, applications, components, modules, software, data structures, user interfaces, etc. described in conjunction with FIGS. 1-8. In some examples, the method may be performed by the service 108 described in detail in FIG. 1.

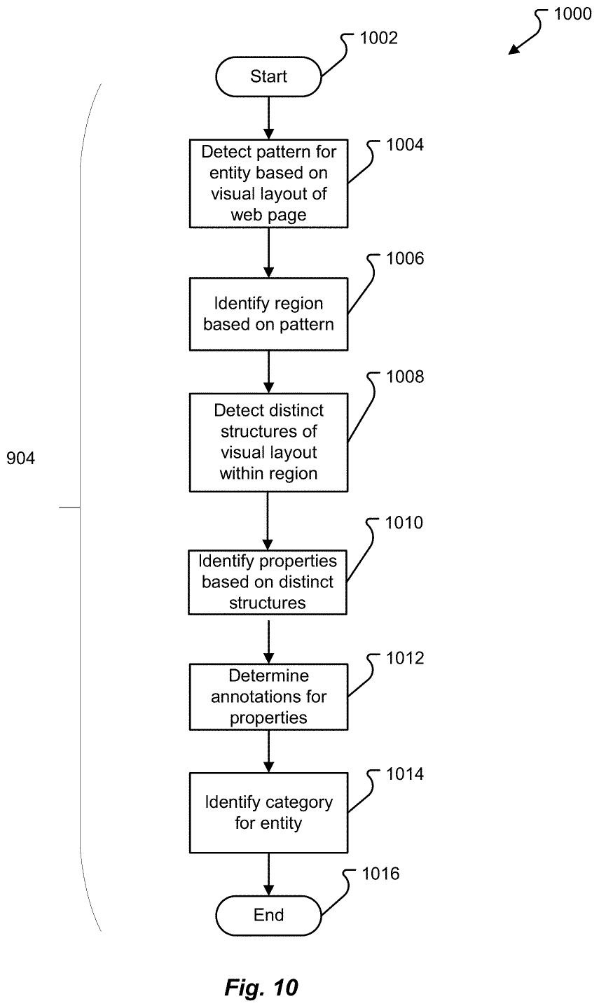

The method 900 starts at start operation 902 and proceeds to operation 904, where entity data may be automatically detected based on a visual layout of a web page, described in further detail in FIG. 10 below. The entity data may be in a semi-structured form within the web page. For example, the entity data may include tags or other markers to separate semantic elements and enforce hierarchies of records and fields within the entity data.

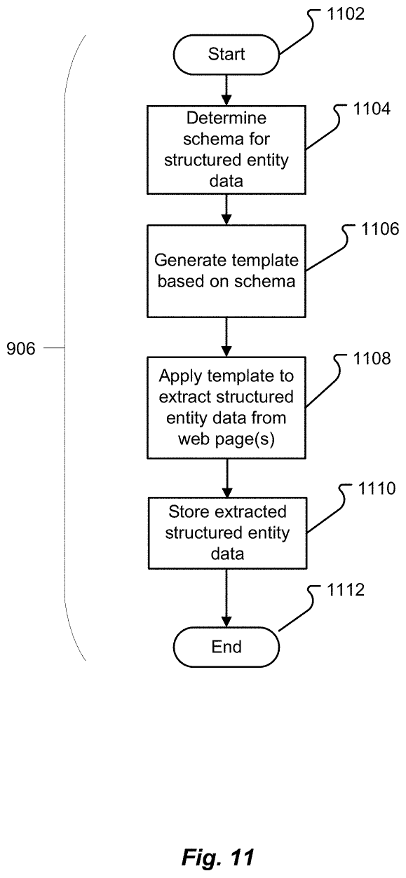

Upon detection of the entity data, the method may proceed to operation 906, where the entity data may be extracted from the web page, described in further detail in FIG. 11 below. The entity data may be extracted in a structured form (i.e., structured entity data). For example, the structured entity data may correspond to a more formal data structure, such as a relational database or other form of data table. The structured entity data may be more easily stored and consumed.

Once the entity data is extracted from the web page, the method may optionally proceed to operation 908, where the extracted structured entity data may be provided for use in one or more services. In some examples, the service 108 executing the method 900 may itself use the structured entity data. In other examples, the extracted structured entity data may be provided to third party services for use. To provide a few non-limiting examples, the extracted structured data may be used to enhance a knowledge graph, relational database, or search engine. The method may then end at end operation 910

FIG. 10 depicts details of a method 1000 for automatically detecting entity data within a web page based on a visual layout of the web page in accordance with examples of the present disclosure. A general order for the steps of the method 1000 is shown in FIG. 10. Generally, the method 1000 starts with a start operation 1002 and ends with the end operation 1016. The method 1000 may include more or fewer steps or may arrange the order of the steps differently than those shown in FIG. 10. The method 1000 may be executed as a set of computer-executable instructions executed by a computer system and encoded or stored on a computer readable medium. Further, the method 1000 may be performed by gates or circuits associated with a processor, Application Specific Integrated Circuit (ASIC), a field programmable gate array (FPGA), a system on chip (SOC), or other hardware device. Hereinafter, the method 1000 shall be explained with reference to the systems, services, applications, components, modules, software, data structures, user interfaces, etc. described in conjunction with FIGS. 1-8. In some examples, the method may be performed by the detection component 112 described in detail in FIG. 1.

In some examples, the method 1000 may be used to at least partially perform operation 904. The method 1000 starts at start operation 1002 and proceeds to operation 1004, where a pattern for an entity may be detected based on a visual layout of a web page. In example aspects, to detect the pattern, a plurality of candidates for the pattern may be generated using one or more algorithms. For example, a brute force algorithm, a heuristic algorithm and/or a machine learning based algorithm, among other similar algorithms, may be used to detect the plurality of candidates based on the visual layout of the web page. A classifying mechanism may then be implemented to determine one candidate among the plurality of candidates for selection as the detected pattern for the entity. In some aspects, the pattern may be a repetitive pattern for a plurality of entities within the web page. As one example, within a web page of a video sharing website (e.g., web page 300), a plurality of media content items may be displayed, where each media content item may have a same or similar pattern as each other of the media content items. Once the pattern is detected, the method 1000 may proceed to operation 1006, where a region of the web page corresponding to the pattern may be identified. This identified region may comprise data associated with the entity. The entity data may be in a semi-structured form.

Upon identification of the region, the method 1000 may proceed to operation 1008, where distinct structures of the visual layout within the region may be detected. The distinct structures may include distinct fonts within the region. A distinct font may include one or more of a distinct font family, font size, font style, font variant, and font weight. Other example distinct structures may be based on an arrangement, position, or orientation of text or graphical content within the region.

Once the distinct structures are detected, the method may proceed to operation 1010 to identify properties based on the distinct structures. For example, a candidate for a property may be identified for and correspond to each distinct structure. In some aspects, the candidate property may be validated by comparing the candidate property to another candidate property of another region of the web page corresponding to the pattern.

Upon detection of the properties, the method 1000 may proceed to operation 1012, where annotations may be determined for the properties. The annotations may include a name and/or description of the properties. The web page may be encoded as an XML document and represented as a tree structure by a DOM tree, where each node in the DOM tree is an object representing a part of the web page and one or more of the objects include markup information. In some examples, the annotations may be determined using the markup information from the DOM tree. In other examples, the annotations may be determined from textual content or other content features of the web page. For example, named-entity recognition may be applied to detect whether the textual content associated with a detected property includes an address, a name, or a number, among other similar information. Additionally, the annotations may be inferred by other content from the web page or the website the web page is associated with. In further examples, the annotations may be determined or adjusted based on the category identified for the entity at operation 1014, described below.

Once the annotations are determined, the method 1000 may proceed to operation 1014, where a category for the entity may be identified. In some aspects, the category may be identified based on the annotations determined at operation 1010. In other aspects, the category may be inferred based on one or more topics and keywords identified from content of the webpage. In further examples, the category may be identified based on a combination of the annotations and the one or more of the topics and keywords. The method may then end at end operation 1016.

FIG. 11 depicts details of a method 1100 for automatically extracting entity data from a web page in accordance with examples of the present disclosure. A general order for the steps of the method 1100 is shown in FIG. 11. Generally, the method 1100 starts with a start operation 1102 and ends with the end operation 1114. The method 1100 may include more or fewer steps or may arrange the order of the steps differently than those shown in FIG. 11. The method 1100 may be executed as a set of computer-executable instructions executed by a computer system and encoded or stored on a computer readable medium. Further, the method 1100 may be performed by gates or circuits associated with a processor, Application Specific Integrated Circuit (ASIC), a field programmable gate array (FPGA), a system on chip (SOC), or other hardware device. Hereinafter, the method 1000 shall be explained with reference to the systems, services, applications, components, modules, software, data structures, user interfaces, etc. described in conjunction with FIGS. 1-8. In some examples, the method may be performed by the service 108 described in detail in FIG. 1.

In some aspects, the method 1100 can be used to at least partially perform operation 906 of method 900. The method 1100 starts at start operation 1102 and proceeds to operation 1104, where a schema for a structured form of the entity data (i.e., structured entity data) may be determined. The schema may be determined based on the properties, annotations, and category identified by method 1000.

Once the schema is determined, the method 1100 may proceed to 1106, where a template may be generated based on the schema. In some aspects, the template may be a template based on a visual layout. For example, information corresponding to the visual layout of the web page may be embedded into the template, and the information may be used to identify a location of the structured entity data within the document. In other aspects, the template may be a rule based or tree node template. For example, the template may contain rules, in form of a regular expression (“regex”) or Xpath, among other similar examples, that define how to locate content in the web page based on text or metadata of the web page. For example, how to locate the content based on markup information (e.g., a markup name or markup attribute) from the DOM tree.

Upon generation of the template, the method 1100 may proceed to 1108, where the template is applied to at least the web page to extract the structured entity data from the web page. In some examples, the template may also be applied to one or more other web pages to extract the structured entity data from the other web pages. The other web pages may be web pages associated with a same website as the web page in which the entity data was detected. In other examples, the other web pages may be web pages across different domains having the same or similar entities.

Once the structured data is extracted, the method 1100 may proceed to 1110 where the extracted structured data may be stored. The method 1100 may then end at end operation 1112.

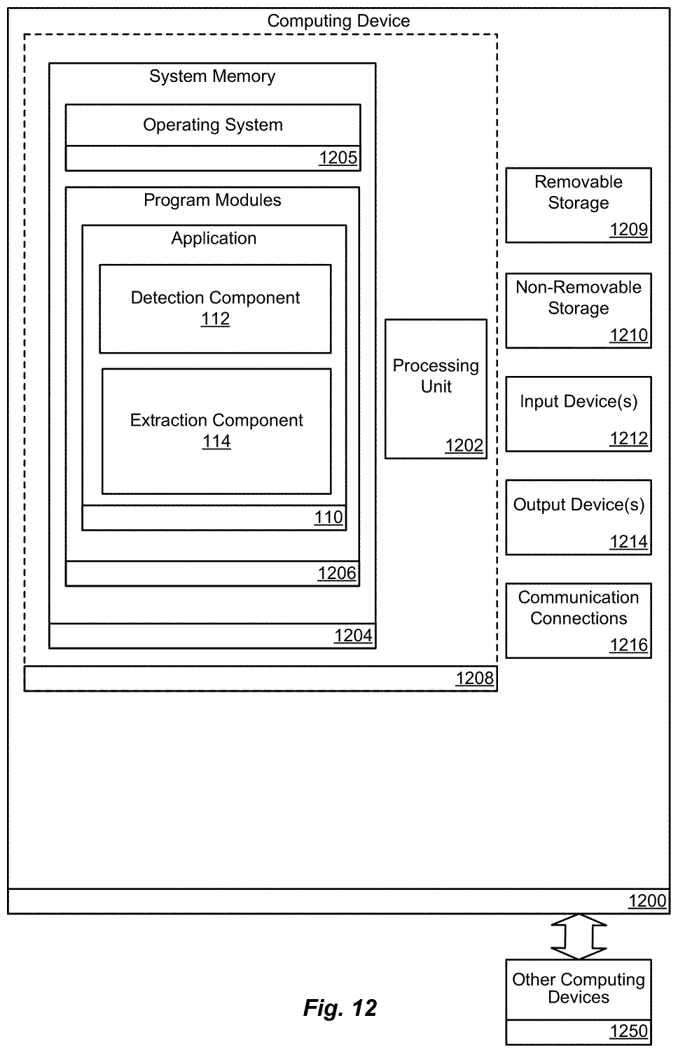

FIG. 12 is a block diagram illustrating physical components (e.g., hardware) of a computing device 1200 with which aspects of the disclosure may be practiced. The computing device components described below may be suitable for the computing devices, such as the web servers 102, the client devices 106, and/or the processing servers 118 of the service 108, as described above. In a basic configuration, the computing device 1200 may include at least one processing unit 1202 and a system memory 1204. Depending on the configuration and type of computing device, the system memory 1204 may comprise, but is not limited to, volatile storage (e.g., random access memory), non-volatile storage (e.g., read-only memory), flash memory, or any combination of such memories. The system memory 1204 may include an operating system 1205 and one or more program modules 1206 suitable for performing the various aspects disclosed herein such as the detection component 112 and the extraction component of the application 110. The operating system 1205, for example, may be suitable for controlling the operation of the computing device 1200. The operating system 1205, for example, may be suitable for detecting and extracting entity data from web pages. Furthermore, aspects of the disclosure may be practiced in conjunction with a graphics library, other operating systems, or any other application program and is not limited to any particular application or system. This basic configuration is illustrated in FIG. 12 by those components within a dashed line 1208. The computing device 1200 may have additional features or functionality. For example, the computing device 1200 may also include additional data storage devices (removable and/or non-removable) such as, for example, magnetic disks, optical disks, or tape. Such additional storage is illustrated in FIG. 12 by a removable storage device 1209 and a non-removable storage device 1210.

As stated above, a number of program modules and data files may be stored in the system memory 1204. While executing on the processing unit 1202, the program modules 1206 (e.g., one or more applications 1220) may perform processes including, but not limited to, the aspects as described herein. Other program modules that may be used in accordance with aspects of the present disclosure may include Internet browser programs, etc.

Furthermore, aspects of the disclosure may be practiced in an electrical circuit comprising discrete electronic elements, packaged or integrated electronic chips containing logic gates, a circuit utilizing a microprocessor, or on a single chip containing electronic elements or microprocessors. For example, aspects of the disclosure may be practiced via a system-on-a-chip (SOC) where each or many of the components illustrated in FIG. 12 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 1200 on the single integrated circuit (chip). Aspects of the disclosure may also be practiced using other technologies capable of performing logical operations such as, for example, AND, OR, and NOT, including but not limited to mechanical, optical, fluidic, and quantum technologies. In addition, aspects of the disclosure may be practiced within a general purpose computer or in any other circuits or systems.

The computing device 1200 may also have one or more input device(s) 1212 such as a keyboard, a mouse, a pen, a sound or voice input device, a touch or swipe input device, etc. The output device(s) 124 such as a display, speakers, a printer, etc. may also be included. The aforementioned devices are examples and others may be used. The computing device 1200 may include one or more communication connections 1216 allowing communications with other computing devices 1250. Examples of suitable communication connections 1216 include, but are not limited to, radio frequency (RF) transmitter, receiver, and/or transceiver circuitry; universal serial bus (USB), parallel, network interface card, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 1204, the removable storage device 1209, and the non-removable storage device 1210 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 1200. Any such computer storage media may be part of the computing device 1200. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

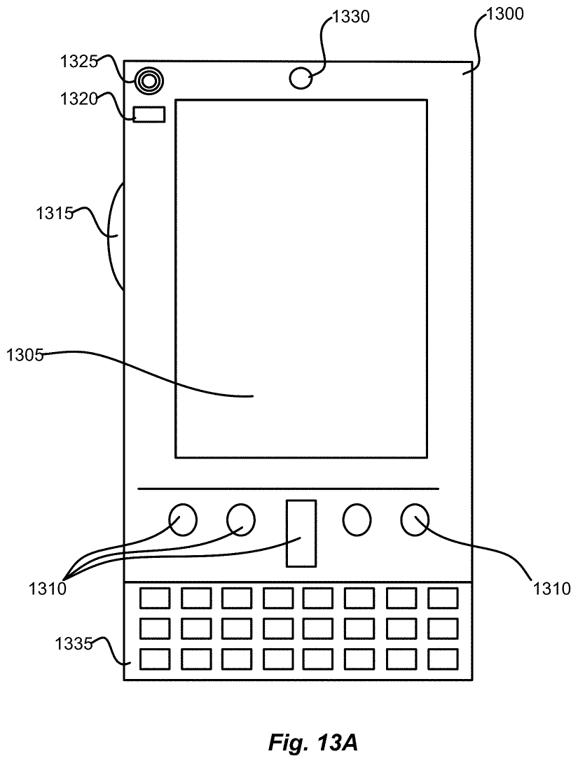

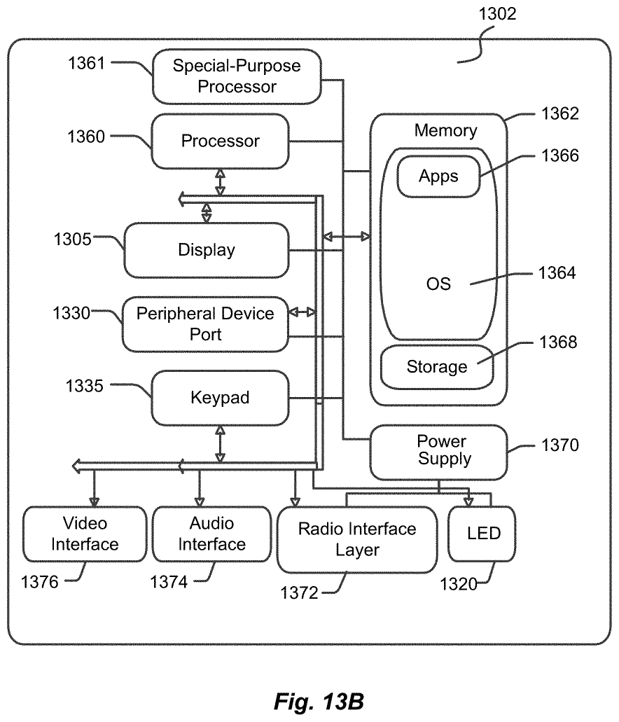

FIGS. 13A and 13B illustrate a computing device, client device, or mobile computing device 1300, for example, a mobile telephone, a smart phone, wearable computer (such as a smart watch), a tablet computer, a laptop computer, and the like, with which aspects of the disclosure may be practiced. In some aspects, one or more of the client devices (e.g., 106) may be a mobile computing device. With reference to FIG. 13A, one aspect of a mobile computing device 1300 for implementing the aspects is illustrated. In a basic configuration, the mobile computing device 1300 is a handheld computer having both input elements and output elements. The mobile computing device 1300 typically includes a display 1305 and one or more input buttons 1310 that allow the user to enter information into the mobile computing device 1300. The display 1305 of the mobile computing device 1300 may also function as an input device (e.g., a touch screen display). If included, an optional side input element 1315 allows further user input. The side input element 1315 may be a rotary switch, a button, or any other type of manual input element. In alternative aspects, mobile computing device 1300 may incorporate more or less input elements. For example, the display 1305 may not be a touch screen in some aspects. In yet another alternative aspect, the mobile computing device 1300 is a portable phone system, such as a cellular phone. The mobile computing device 1300 may also include an optional keypad 1335. Optional keypad 1335 may be a physical keypad or a “soft” keypad generated on the touch screen display. In various aspects, the output elements include the display 1305 for showing a graphical user interface (GUI), a visual indicator 1320 (e.g., alight emitting diode), and/or an audio transducer 1325 (e.g., a speaker). In some aspects, the mobile computing device 1300 incorporates a vibration transducer for providing the user with tactile feedback. In yet another aspect, the mobile computing device 1300 incorporates input and/or output ports, such as an audio input (e.g., a microphone jack), an audio output (e.g., a headphone jack), and a video output (e.g., a HDMI port) for sending signals to or receiving signals from an external source.

FIG. 13B is a block diagram illustrating the architecture of one aspect of computing device, a server (e.g., web servers 102 and processing servers 118), or a mobile computing device (e.g., client device 106). That is, the computing device 1300 can incorporate a system (e.g., an architecture) 1302 to implement some aspects. The system 1302 can implemented as a “smart phone” capable of running one or more applications (e.g., application 110, among other applications). In some aspects, the system 1302 is integrated as a computing device, such as an integrated personal digital assistant (PDA) and wireless phone.

One or more application programs 1366 may be loaded into the memory 1362 and run on or in association with the operating system 1364. Examples of the application programs include Internet browser programs, data detection programs (e.g., detection component 112), data extraction programs (e.g., extraction component 114), and so forth. The system 1302 also includes a non-volatile storage area 1368 within the memory 1362. The non-volatile storage area 1368 may be used to store persistent information that should not be lost if the system 1302 is powered down. The application programs 1366 may use and store information in the non-volatile storage area 1368, such as web pages, schemas, templates, extracted entity data, and the like. A synchronization application (not shown) also resides on the system 1302 and is programmed to interact with a corresponding synchronization application resident on a host computer to keep the information stored in the non-volatile storage area 1368 synchronized with corresponding information stored at the host computer. As should be appreciated, other applications may be loaded into the memory 1362 and run on the mobile computing device 1300 described herein (e.g., application 110 etc.).

The system 1302 has a power supply 1370, which may be implemented as one or more batteries. The power supply 1370 might further include an external power source, such as an AC adapter or a powered docking cradle that supplements or recharges the batteries.

The system 1302 may also include a radio interface layer 1372 that performs the function of transmitting and receiving radio frequency communications. The radio interface layer 1372 facilitates wireless connectivity between the system 1302 and the “outside world,” via a communications carrier or service provider. Transmissions to and from the radio interface layer 1372 are conducted under control of the operating system 1364. In other words, communications received by the radio interface layer 1372 may be disseminated to the application programs 1366 via the operating system 1364, and vice versa.

The visual indicator 1320 may be used to provide visual notifications, and/or an audio interface 1374 may be used for producing audible notifications via the audio transducer 1325. In the illustrated configuration, the visual indicator 1320 is a light emitting diode (LED) and the audio transducer 1325 is a speaker. These devices may be directly coupled to the power supply 1370 so that when activated, they remain on for a duration dictated by the notification mechanism even though the processor 1360 and other components might shut down for conserving battery power. The LED may be programmed to remain on indefinitely until the user takes action to indicate the powered-on status of the device. The audio interface 1374 is used to provide audible signals to and receive audible signals from the user. For example, in addition to being coupled to the audio transducer 1325, the audio interface 1374 may also be coupled to a microphone to receive audible input, such as to facilitate a telephone conversation. In accordance with aspects of the present disclosure, the microphone may also serve as an audio sensor to facilitate control of notifications, as will be described below. The system 1302 may further include a video interface 1376 that enables an operation of an on-board camera 1330 to record still images, video stream, and the like.

A mobile computing device 1300 implementing the system 1302 may have additional features or functionality. For example, the mobile computing device 1300 may also include additional data storage devices (removable and/or non-removable) such as, magnetic disks, optical disks, or tape. Such additional storage is illustrated in FIG. 13B by the non-volatile storage area 1068.

Data/information generated or captured by the mobile computing device 1300 and stored via the system 1302 may be stored locally on the mobile computing device 1300, as described above, or the data may be stored on any number of storage media that may be accessed by the device via the radio interface layer 1372 or via a wired connection between the mobile computing device 1300 and a separate computing device associated with the mobile computing device 1300, for example, a server computer in a distributed computing network, such as the Internet. As should be appreciated such data/information may be accessed via the mobile computing device 1300 via the radio interface layer 1372 or via a distributed computing network. Similarly, such data/information may be readily transferred between computing devices for storage and use according to well-known data/information transfer and storage means, including electronic mail and collaborative data/information sharing systems.

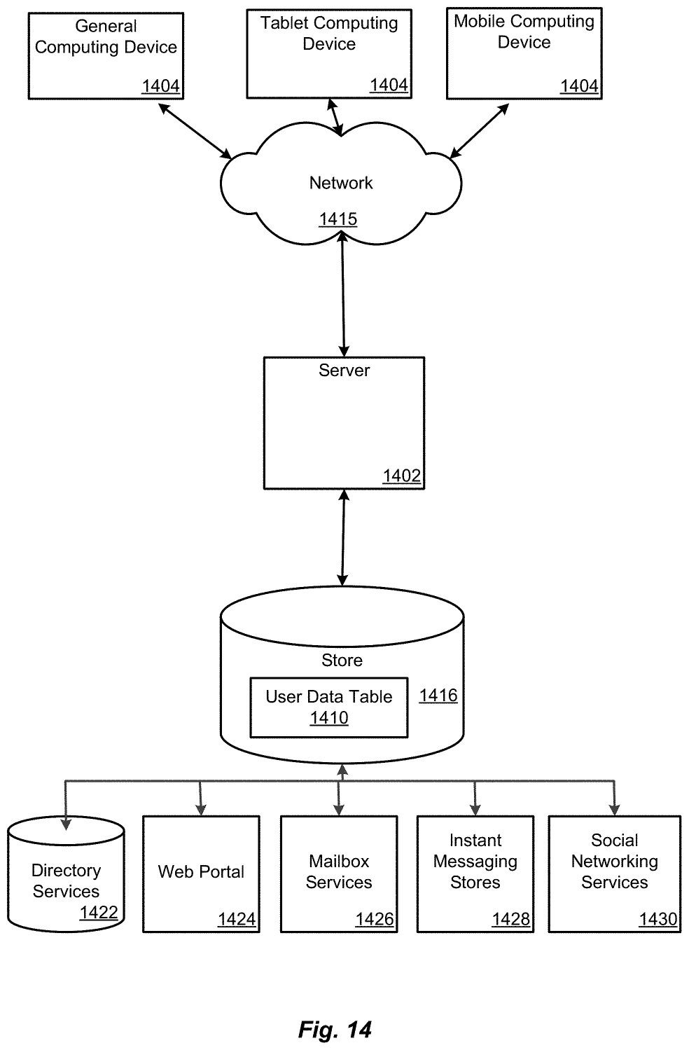

FIG. 14 illustrates one aspect of the architecture of a system for processing a web page received at a server device 1402 (e.g., web servers 102, processing servers 118 of service 108, or client devices 106) to detect and extract entity data, as described above. Content at a server device 1402 may be stored in different communication channels or other storage types. For example, various web pages, entity data, schemas, and templates may be stored using a directory service 1422, a web portal 1424, a mailbox service 1426, an instant messaging store 1428, or a social networking site 1430. A unified profile API based on the user data table 1410 may be employed by a client that communicates with server device 1402, and/or the content generator may be employed by server device 1402. The server device 1402 may provide data to and from a client computing device such as the client devices 106 and/or the third party services 120 through a network 1415. By way of example, the client devices 106 described above may be embodied in a personal computer 1404, a tablet computing device 1406, and/or a mobile computing device 1408 (e.g., a smart phone). Any of these configurations of the computing devices may request a web page from one or more of the web servers 102, and receive the web page responsive to the request.

The above specification, examples and data provide a complete description of the manufacture and use of the composition of the invention. Since many aspects of the invention can be made without departing from the spirit and scope of the invention, the invention resides in the claims hereinafter appended.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The exemplary systems and methods of this disclosure have been described in relation to computing devices. However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should, however, be appreciated that the present disclosure may be practiced in a variety of ways beyond the specific detail set forth herein.

Furthermore, while the exemplary aspects illustrated herein show the various components of the system collocated, certain components of the system can be located remotely, at distant portions of a distributed network, such as a LAN and/or the Internet, or within a dedicated system. Thus, it should be appreciated, that the components of the system can be combined into one or more devices, such as a server, communication device, or collocated on a particular node of a distributed network, such as an analog and/or digital telecommunications network, a packet-switched network, or a circuit-switched network. It will be appreciated from the preceding description, and for reasons of computational efficiency, that the components of the system can be arranged at any location within a distributed network of components without affecting the operation of the system.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

Any of the steps, functions, and operations discussed herein can be performed continuously and automatically.

While the flowcharts have been discussed and illustrated in relation to a particular sequence of events, it should be appreciated that changes, additions, and omissions to this sequence can occur without materially affecting the operation of the disclosed configurations and aspects.

A number of variations and modifications of the disclosure can be used. It would be possible to provide for some features of the disclosure without providing others.

In yet another configurations, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another configuration, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another configuration, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions that may be implemented with particular standards and protocols, the disclosure is not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various configurations and aspects, includes components, methods, processes, systems and/or apparatus substantially as depicted and described herein, including various combinations, subcombinations, and subsets thereof. Those of skill in the art will understand how to make and use the systems and methods disclosed herein after understanding the present disclosure. The present disclosure, in various configurations and aspects, includes providing devices and processes in the absence of items not depicted and/or described herein or in various configurations or aspects hereof, including in the absence of such items as may have been used in previous devices or processes, e.g., for improving performance, achieving ease, and/or reducing cost of implementation.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an configuration with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

In accordance with at least one example of the present disclosure, a system to automatically detect entity data within a web page is provided. The system may include at least one processor and at least one memory including instructions which when executed by the at least one processor, causes the at least one processor to detect a pattern for an entity based on a visual layout of the web page, identify a region of the web page corresponding to the pattern, the region including the entity data; detect a property associated with the entity within the region, determine an annotation for the property, and identify a category for the entity based on the annotation.

At least one aspect of the above example includes where the entity data may be in a semi-structured form within the web page, and the instructions may further cause the at least one processor to determine a schema for a structured form of the entity data based on the property, the annotation, and the category. Also, at least one aspect of the above example includes where a template for the web page may be generated based on the schema. The template may be a visual layout based template. The template may be a rule based template.

Further, at least one aspect of the above example includes where the instructions may further cause the at least one processor to extract the entity data in the structured form from the web page using the template. Further still, at least one aspect of the above example includes where the instructions may further cause the at least one processor to provide the structured entity data extracted from the web page for use in a service. Yet further still, at least one aspect of the above example includes where the instructions may further cause the at least one processor to apply the template to another web page to extract entity data in the structured form from the other web page. The other web page may be associated with a same website as the web page.

In accordance with at least one example of the present disclosure, a method for automatically detecting entity data within a web page is provided. The method may include detecting a pattern for an entity based on a visual layout of the web page and identifying a region of the web page corresponding to the pattern, the region including the entity data in a semi-structured form. The method may also include detecting a distinct structure of the visual layout within the region, identifying a property associated with the entity corresponding to the distinct structure, determining an annotation for the property, and identifying a category for the entity based on the annotation. The method may further include determining a schema for a structured form of the entity data based on the property, the annotation, and the category.

At least one aspect of the above example includes detecting a distinct font within the region, where detecting the distinct font may include detecting a distinct font family, font size, font style, font variant, and/or font weight. Also, at least one aspect of the above example includes identifying a candidate for the property corresponding to the distinct structure, and validating the candidate by comparing the candidate to another candidate identified within another region of the web page corresponding to the pattern to identify the property. Further, at least one aspect of the above example includes determining the annotation for the property by using markup data from the web page to determine a description for the property. Additionally, the annotation may be adjusted based on the category identified for the entity. Further still, at least one aspect of the above example includes identifying the category for the entity further based on one or more topics and keywords identified from content of the web page.

At least another aspect of the above example includes extracting the entity data from the web page in a structured form by generating a template for the web page based on the schema, and applying the template to the web page to extract the entity data in the structured form from the web page.

In accordance with at least one example of the present disclosure, a computer storage media is provided. The computer storage media may contain computer executable instructions, which when executed by a computer, perform a method for automatically detecting and extracting entity data from a web page. The method may include automatically detecting the entity data within the web page based on a visual layout of the web page, where the entity data is in a semi-structured form within the web page, generating a template based on a schema for a structured form of the entity data, applying the template to the web page to extract the entity data in the structured form from the web page, and providing the structured entity data for use in one or more services.

At least one aspect of the above example includes where the structured entity data may be used in one or more services executed by the computer and/or the structured entity data may be provided to one or more third party services for use.

Any one or more of the aspects as substantially disclosed herein.

Any one or more of the aspects as substantially disclosed herein optionally in combination with any one or more other aspects as substantially disclosed herein.

One or means adapted to perform any one or more of the above aspects as substantially disclosed herein.

What is claimed is:

1. A system to automatically detect entity data within a web page, the system comprising:
at least one processor; and
at least one memory including instructions which when executed by the at least one processor, causes the at least one processor to:
detect a pattern for an entity based on a visual layout of the web page;
identify a region of the web page corresponding to the pattern, the region including the entity data;
within the region, detect a property associated with the entity;
determine an annotation for the property; and
identify a category for the entity based on the annotation.

2. The system of claim 1, wherein the entity data is in a semi-structured form within the web page.

3. The system of claim 2, wherein the instructions further cause the at least one processor to determine a schema for a structured form of the entity data based on the property, the annotation, and the category.

4. The system of claim 3, wherein the instructions further cause the at least one processor to generate a template for the web page based on the schema.

5. The system of claim 4, wherein the template is a visual layout based template.

6. The system of claim 4, wherein the template is a rule based template.

7. The system of claim 4, wherein the instructions further cause the at least one processor to extract the entity data in the structured form from the web page using the template.

8. The system of claim 7, wherein the instructions further cause the at least one processor to provide the structured entity data extracted from the web page for use in a service.

9. The system of claim 4, wherein the instructions further cause the at least one processor to apply the template to another web page to extract entity data in the structured form from the other web page.

10. The system of claim 9, wherein the other web page is associated with a same website as the web page.

11. A method for automatically detecting entity data within a web page, the method comprising:
detecting a pattern for an entity based on a visual layout of the web page;
identifying a region of the web page corresponding to the pattern, the region including the entity data in a semi-structured form;
within the region, detecting a distinct structure of the visual layout;
identifying a property associated with the entity corresponding to the distinct structure;
determining an annotation for the property;
identifying a category for the entity based on the annotation; and
determining a schema for a structured form of the entity data based on the property, the annotation, and the category.

12. The method of claim 11, wherein detecting the distinct structure of the visual layout comprises:
detecting a distinct font within the region.

13. The method of claim 12, wherein detecting the distinct font within the region comprises:
detecting one or more of a distinct font family, font size, font style, font variant, and font weight.

14. The method of claim 11, wherein identifying the property further comprises:
identifying a candidate for the property corresponding to the distinct structure; and
validating the candidate by comparing the candidate to another candidate identified within another region of the web page corresponding to the pattern.

15. The method of claim 11, wherein determining the annotation for the property comprises:
using markup data from the web page to determine a description for the property.

16. The method of claim 11, further comprising:
adjusting the annotation based on the category identified for the entity.

17. The method of claim 11, wherein identifying the category for the entity comprises:
identifying the category for the entity further based on one or more topics and keywords identified from content of the web page.

18. The method of claim 11, further comprising:
extracting the entity data from the web page in a structured form by:
generating a template for the web page based on the schema; and
applying the template to the web page to extract the entity data in the structured form from the web page.

19. A computer storage media containing computer executable instructions, which when executed by a computer, perform a method for automatically detecting and extracting entity data from a web page, the method comprising:
automatically detecting the entity data within the web page based on a visual layout of the web page, wherein the entity data is in a semi-structured form within the web page;
generating a template based on a schema for a structured form of the entity data;
applying the template to the web page to extract the entity data in the structured form from the web page; and
providing the structured entity data for use in one or more services.

20. The computer storage media of claim 19, wherein one or more of:
the structured entity data is used in one or more services executed by the computer; and
the structured entity data is provided to one or more third party services for use.
